(19) United States
(12) Patent Application Publication
(10) Pub. No.: US 2013/0173218 A1
(43) Pub. Date: Jul. 4, 2013

(54) Malfunction Detection Method and System Thereof

(71) Applicants: Shunji Maeda, Yokohama (JP); Hisae Shibuya, Chigasaki (JP)

(72) Inventors: Shunji Maeda, Yokohama (JP); Hisae Shibuya, Chigasaki (JP)

(73) Assignee: Hitachi, Ltd., Chiyoda-ku (JP)

(21) Appl. No.: 13/702,531

(22) PCT Filed: May 16, 2011
(86) PCT No.: PCT/JP2011/061233

§ 371 Date: Dec. 6, 2012

(30) Foreign Application Priority Data
Sep. 7, 2010 (JP) 2010-199672

(51) Int. Cl. G06F 17/00

(52) U.S. Cl. CPC G06F 17/00
USPC 702/182

(57) ABSTRACT

To allow early sensing of anomalies in a manufacturing plant or other infrastructure (plant), provided is a method that acquires data of runtime status of said plant from a plurality of sensors of said plant, makes a model from training data that corresponds to the regular runtime status of said plant, employs the training data thus modeled in computing a anomaly measure of the data acquired from the sensors, and detects anomalies. In computing the anomaly measure, the anomaly is detected by recursively carrying out: a derivation of a residual error from the training data thus modeled acquired from the plurality of sensors, a removal of a signal having a residual error that is greater than a predetermined value, and a computation of the anomaly measure for the data that is acquired from the plurality of sensors whereupon the signal having the large residual error is removed.

### TECHNICAL FIELD

The present invention relates to a anomaly detection method and a system thereof that quickly detect an anomaly of a plant or an installation.

### BACKGROUND ART

Electric power companies supply warm water for regional heating systems using waste heat of gas turbines or supply high- or low-pressure steam to factories. Petrochemical companies operate gas turbines as power source installations. In various plants and installations using the gas turbines as described above, it is highly important to quickly find an anomaly because damage to society can be minimized.

Other than the gas turbines, there are too many installations for which anomalies, including deterioration/lifetime of batteries mounted even in devices or parts, need to be quickly detected, such as gas engines, steam turbines, water turbines in hydraulic power plants, nuclear reactors in nuclear power plants, wind turbines in wind power plants, engines of airplanes and heavy machines, railroad vehicles and rail tracks, escalators, elevators, medical equipment such as MRI and CT scanning devices, and manufacturing/inspection devices for semiconductor and flat-panel displays. In recent years, it is becoming important to detect anomalies (various symptoms) of human bodies as in an electroencephalographic measurement/diagnosis for health maintenance.

Therefore, for example, Patent Literature 1 and Patent Literature 2 describe that anomaly detection is performed as services mainly for engines. In each method, past data is kept as a database (DB), similarity between observed data and past learning data is calculated by a unique method, an estimate value is calculated by linear combination of data that is high in similarity, and a misfit degree between the estimate value and the observed data is output. Patent Literature 3 describes an example of detecting an anomaly by k-means clustering.

### CITATION LIST

### Patent Literature

Patent Literature 1: U.S. Pat. No. 6,952,662
Patent Literature 2: U.S. Pat. No. 6,975,962
Patent Literature 3: U.S. Pat. No. 6,216,066
Patent Literature 4: Japanese Patent Application
Laid-Open Publication No. 2000-30065

### Non Patent Literature

Non patent Literature 1: Stephan W. Wegerich; Nonparametric modeling of vibration signal features for equipment health monitoring; Aerospace Conference, 2003. Proceedings. 2003 IEEE, Volume 7, Issue, 2003:pp. 3113-3121
Non patent Literature 2: Kenichi MAEDA, Teiichi WATANABE; Pattern matching method introducing local structure; Trans. IECE Japan, (D)J68-D, 3, pp. 345-352, 1985

### SUMMARY OF INVENTION

### Technical Problem

In general, a system that detects an anomaly by monitoring observed data to be compared with a set threshold value is used in many cases. In this case, the threshold value is set by focusing on the physical quantity of a measurement target as each observed data, and thus the method is regarded as physical-based anomaly detection according to a design standard. In this method, it is difficult to detect an anomaly that is not intended by a designer, and there is a possibility to overlook the anomaly. For example, the set threshold value is not considered to be appropriate due to working environments of installations, state changes associated with working years, operation conditions of users, and effects of part replacement. On the other hand, in the methods on the basis of example-based anomaly detection described in Patent Literature 1 and Patent Literature 2, learning data that is high in similarity with observed data is linearly combined to calculate an estimate value, and a misfit degree between the estimate value and the observed data is output, so that working environments of installations, state changes associated with working years, operation conditions, and effects of part replacement can be considered to some extent depending on preparation of the learning data. However, if plural and composite anomalies occur, some phenomena cannot be seen depending on an anomaly, and there are some anomalies that are difficult to be detected. As a result, they are overlooked. It is more difficult to detect composite anomalies in a feature space whose physical meaning is vague, such as k-means clustering described in Patent Literature 3.

Further, in a transient period of a signal where the operation state of the installation changes, the number of pieces of learning data is small, and the data is largely changed. In addition, the levels of sampling errors become considerably high. As a result, a misfit degree between a predicted estimate value and observed data becomes instable, hindering the anomaly detection.

Accordingly, an object of the present invention is to enable an example-based anomaly detection method to adapt to composite anomalies while considering working environments of installations, state changes associated with working years, operation conditions, and effects of part replacement depending on preparation of learning data. Accordingly, the object of the present invention is to provide a anomaly detection method and a system thereof in which if anomalies occur at the same time, plural anomalies occur at short intervals, or the anomalies are of different types, these anomalies or signs can be quickly detected with high sensitivity. Further, the present invention provides a anomaly detection method and a system thereof that can be adapted to a transient period of a signal.

### Solution to Problem

In order to achieve the above-described object, the present invention targets output signals of multidimensional sensors attached to an installation, prepares nearly-normal learning data based on example-based anomaly detection by a multivariate analysis, and expresses a deviation degree from the learning data using a distance from observed data to learning data and temporal moving trajectories of the observed data and learning data in a method of expressing the state of an installation.

Specifically, in order to adapt to composite anomalies, (1) an anomaly is determined based on a deviation degree, and (2) a deviation degree is obtained for each sensor signal to specify a causal signal. In order to grasp the presence of another potential anomaly, (3) a sensor signal with a large degree of deviation is removed, and the deviation degree is obtained again to determine an anomaly. The processes are repeated until no deviation is found. The signal is deleted based on statistical recognition, attributes (function, region, correlation, and the like), or combinations thereof.

It should be noted that learning data is modeled by a subspace method and an anomaly candidate is detected on the basis of a distance relation between observed data and a subspace in the example-based anomaly detection.

Further, k pieces of data that are higher in similarity are obtained for each data included in learning data in each observed data, and a subspace is accordingly generated. The number k is not a fixed value, and learning data within a predetermined distance from the observed data is selected to set an appropriate value for each observed data. The number of pieces of learning data is sequentially increased from the minimum number to the selective number, so that learning data with the minimum projection distance may be selected. Further, pieces of learning data that are obtained before and after the time of the selected learning data are added to the selected learning data, so that the present invention can adapt to sampling errors of a transient period.

As a way of providing the method or system for customers, the method that detects an anomaly is realized by a program, and the program is provided for the customers through media or on-line services.

### Advantageous Effects of Invention

According to the present invention, if anomalies occur at the same time, plural anomalies occur at short intervals, or the anomalies are of different types, these anomalies or signs can be quickly detected with high sensitivity. Accordingly, it is possible to prevent an anomaly to be overlooked. Further, the state of an installation can be more accurately grasped and expressed without wrongly recognizing the cause of the detected anomaly. Accordingly, a potential anomaly can be detected with high sensitivity.

Accordingly, anomalies, including deterioration/lifetime of batteries mounted even in devices or parts, can be quickly detected with a high degree of accuracy in not only installations such as gas turbines and steam turbines, but also various installations and parts such as water turbines in hydraulic power plants, nuclear reactors in nuclear power plants, wind turbines in wind power plants, engines of airplanes and heavy machines, railroad vehicles and rail tracks, escalators, and elevators.

### BRIEF DESCRIPTION OF DRAWINGS

FIG. 1 is a block diagram for showing an example of installations and multidimensional time-series signals targeted by a anomaly detection system of the present invention.

FIG. 2 is a graph of waveform signals for showing an example of the multidimensional time-series signals.

FIG. 3 is a block diagram for showing an entire configuration of the anomaly detection system in an embodiment of the present invention.

FIG. 4 is a block diagram for explaining an example-based anomaly detection method using plural classifiers.

FIG. 5A is a diagram for explaining examples of the classifiers in which explains a projection distance method.

FIG. 5B is a diagram for explaining examples of the classifiers in which explains a local subspace classifier.

FIG. 6A is a diagram for explaining selection of learning data to generate a subspace by a subspace method in which a graph for showing an output signal of a sensor.

FIG. 6B is a diagram for explaining selection of learning data to generate a subspace by a subspace method in which a diagram obtained by plotting sensor signals in a local subspace.

FIG. 7 is a flow diagram for showing a procedure of an anomaly detection method.

FIG. 8A is a diagram for explaining motion vectors in which showing an observed sensor waveform signal.

FIG. 8B is a diagram for explaining motion vectors in which showing a sensor waveform signal serving as learning data.

FIG. 8C is a diagram for explaining motion vectors in which showing observed vectors and similar learning vectors in a multidimensional feature amount space.

FIG. 9 is a table of a list of typical feature conversions.

FIG. 10 is a graph in which an observed signal and an anomaly measurement calculated by a subspace method are displayed.

FIG. 11 is a diagram for showing the trajectories of residual vectors calculated by the subspace method.

FIG. 12 is a graph for showing each residual component signal of the residual vector calculated by the subspace method.

FIG. 13 is a graph for showing the trajectories of the multidimensional time-series signals when plural anomalies occur.

FIG. 14 is a graph that is applied to the data shown in FIG. 13 and shows the anomaly measurement calculated by the subspace method.

FIG. 15 is a graph for showing each residual component signal of the residual vector calculated by the subspace method.

FIG. 16 is a flow diagram for showing a correspondence procedure to composite anomalies according to the embodiment of the present invention.

FIG. 17A shows a result of the procedure shown in FIG. 16 and each residual component signal of the residual vector calculated by the subspace method.

FIG. 17B is a graph in which a residual signal of reactive power detected by a sensor No. 12 of FIG. 17A is digitalized.

FIG. 18A is a graph for showing a sensor output signal when the maximum value and the minimum value of the sensor signal are selected as learning data.

FIG. 18B is a graph for showing a sensor output signal when similar data is selected as learning data.

FIG. 19 is a block diagram for showing a configuration around a processor in the embodiment of the present invention.

FIG. 20A is a block diagram for showing a system configuration that displays time-series data after accepting sensor information from the installation in the embodiment of the present invention.

FIG. 20B is a block diagram for showing a system configuration that detects an anomaly after accepting sensor data and event data to perform an anomaly diagnosis based on the result in the embodiment of the present invention.

FIG. 21A is a graph for showing example of transient period of rise of sensor signal used in the embodiment of the present invention.

FIG. 21B is a graph for showing example of transient period of rise of sensor signal relatively longer than the period of the case in FIG. 21A used in the embodiment of the present invention.

FIG. 21C is a graph for showing examples of transient periods of fall of sensor signal used in the embodiment of the present invention.

FIG. 22 is a diagram for showing an improved example of a local subspace classifier produced using the observed data in the embodiment of the present invention.

FIG. 23A is a graph for showing learning data selected by a range search method in the embodiment of the present invention.

FIG. 23B is a diagram for showing an example of a subspace obtained by an improved subspace method in the embodiment of the present invention.

FIG. 23C is a table obtained by arranging examples of event information in a list.

### DESCRIPTION OF EMBODIMENTS

Hereinafter, an embodiment of the present invention will be described with reference to the drawings.

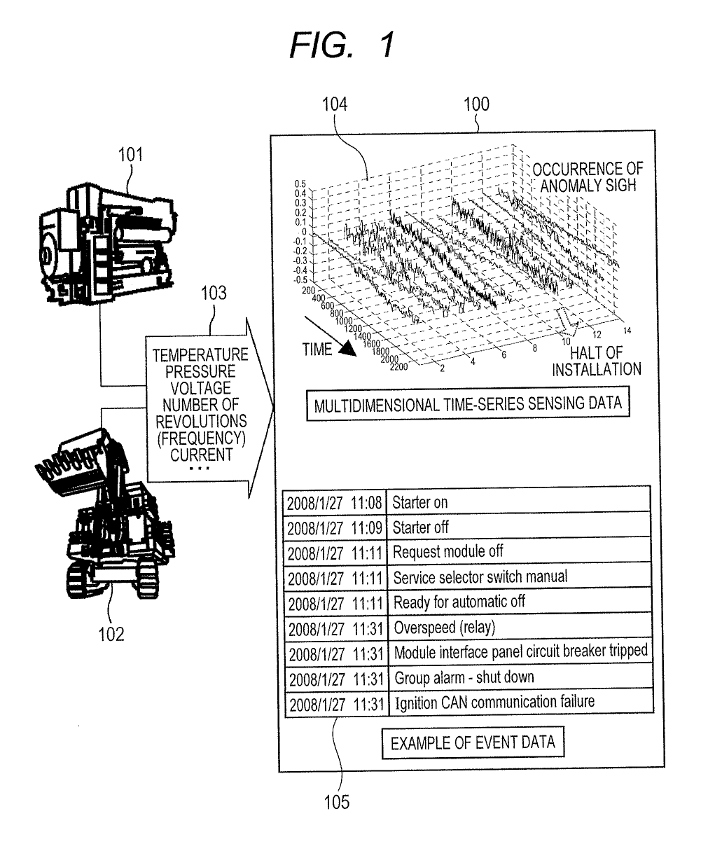

FIG. 1 shows an entire configuration including a anomaly detection system 100 of the present invention. The reference numerals 101 and 102 denote installations that are targeted by the anomaly detection system 100 of the present invention, and each of the installations 101 and 102 is provided with various sensors (not shown). Sensor signals 103 obtained by the sensors are input to the anomaly detection system 100 of the present invention to be processed. The anomaly detection system 100 of the present invention obtains multidimensional time-series sensing data 104 and an event signal 105 from the sensor signals 103, and processes the data to perform anomaly detection for the installations 101 and 102. There are several tens to several tens of thousands of types of sensor signals 103 obtained by the sensors. The type of sensor signal 104 obtained by the multidimensional time-series signal obtaining unit 103 is determined in consideration of the sizes of the installations 101 and 102 and various costs incurred by damage to society when the installations are broken.

The target handled by the anomaly detection system 100 is the multidimensional time-series sensor signal 103, and includes, for example, power generation voltage, an exhaust gas temperature, a cooling water temperature, a cooling water pressure, and operation time. Installation environments and the like are monitored. The sampling timing of the sensor ranges from several tens of milliseconds to several tens of seconds. The event data 105 includes an operation state, breakdown information, and maintenance information of the installations 101 and 102.

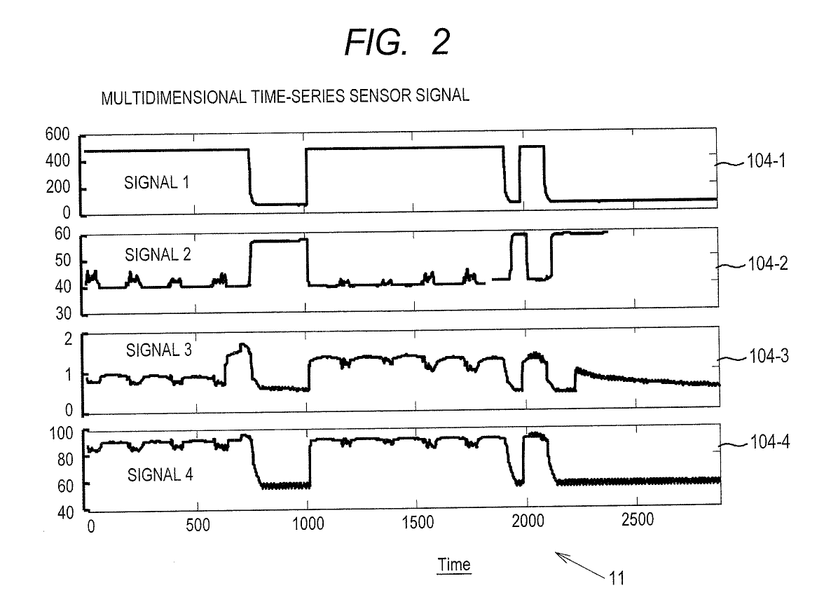

FIG. 2 is a diagram of the sensor signals 104-1 to 104-4 in which the horizontal axis represents time.

FIG. 3 is a diagram for showing a configuration of example-based anomaly detection targeted on the multidimensional sensor signal. This configuration includes a weight/normalization/feature extraction/selection/conversion unit 301 into which the multidimensional time-series sensing data 104 obtained from the installation 101 or 102 is input, a mode analyzing unit 302 that analyzes the mode of the event data 105 (ON/OFF signal control of the installation 101 or 102, various alarms, and information of regular inspection/adjustment of the installation) obtained from the installation 101 or 102, a clustering processing unit 303 that performs a clustering process in response to information of weight/normalization/feature extracted by the weight/normalization/feature extraction/selection/conversion unit 301 and the result of the mode analysis performed by the mode analyzing unit 302, a learning data selection unit 304 that selects learning data in response to the result of the clustering process performed by the clustering processing unit 303, a classifying unit 305 that includes plural classifiers, an integration unit 306 that integrates the results classified by the classifying unit 305, and a verification evaluating unit 307 that verifies and evaluates the results analyzed by the analyzing unit 302 and integrated by the integration unit 306. Among these units, the weight/normalization/feature extraction/selection/conversion unit 301, the mode analyzing unit 302, the clustering processing unit 303, the learning data selection unit 304, the classifying unit 305, the integration unit 306 and the verification evaluating unit 307 are incorporated in a processor 119 shown in FIG. 19.

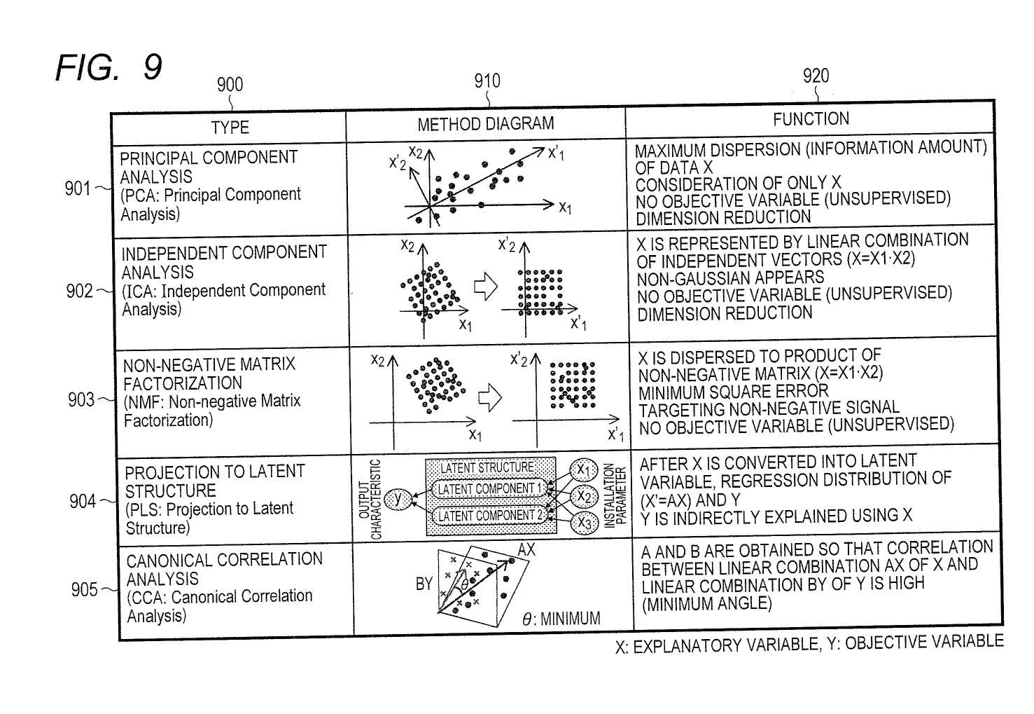

In this configuration, the weight/normalization/feature extraction/selection/conversion unit 301 having received the multidimensional time-series sensing data 104 extracts observed sensor data as outlier relative to normal data by a multivariate analysis, and weighting and normalization are performed for the observed sensor data, if it needs (in the case where the observed sensor data is normalized, the weighting is performed after the normalization). In addition, extraction/selection/various feature conversions are performed for the observed sensor data. The feature conversion will be described in FIG. 9. The clustering processing unit 303 classifies the sensor data into some categories based on the mode in accordance with the operation state or the like. Using the event data 105 (the operation state of the installation, alarm information, or the like) other than the multidimensional time-series sensing data 104, learning data is selected or an anomaly diagnosis is performed in some cases on the basis of the analysis result by the analyzing unit 302. The event data 105 can be classified into some categories based on the mode to be input to the clustering processing unit 303. The analyzing unit 302 analyses and interprets the event data 105. Further, classification is performed using plural classifiers in the classifying unit 305, and the results are integrated by the integration unit 306, so that more robust anomaly detection can be realized. An explanation message for the anomaly is output from the integration unit 306.

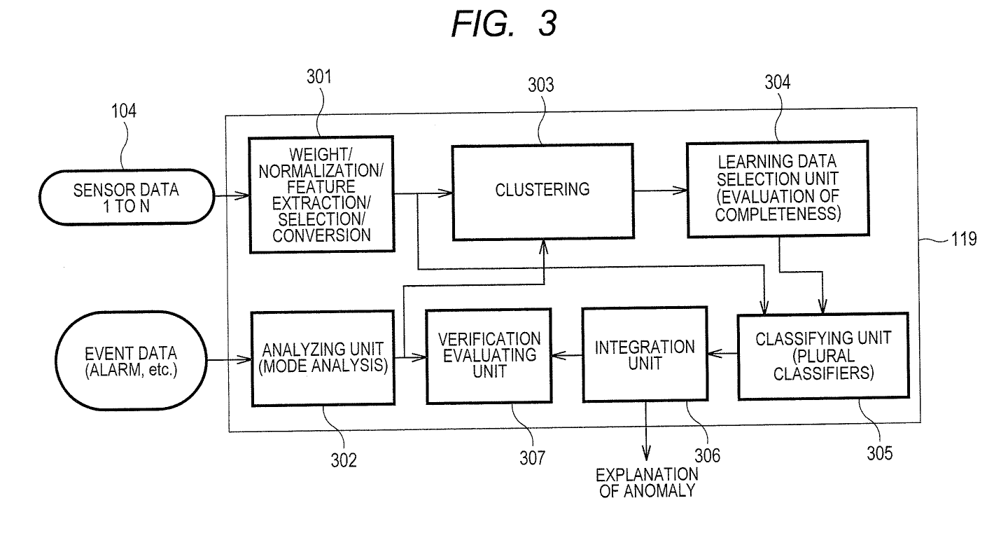

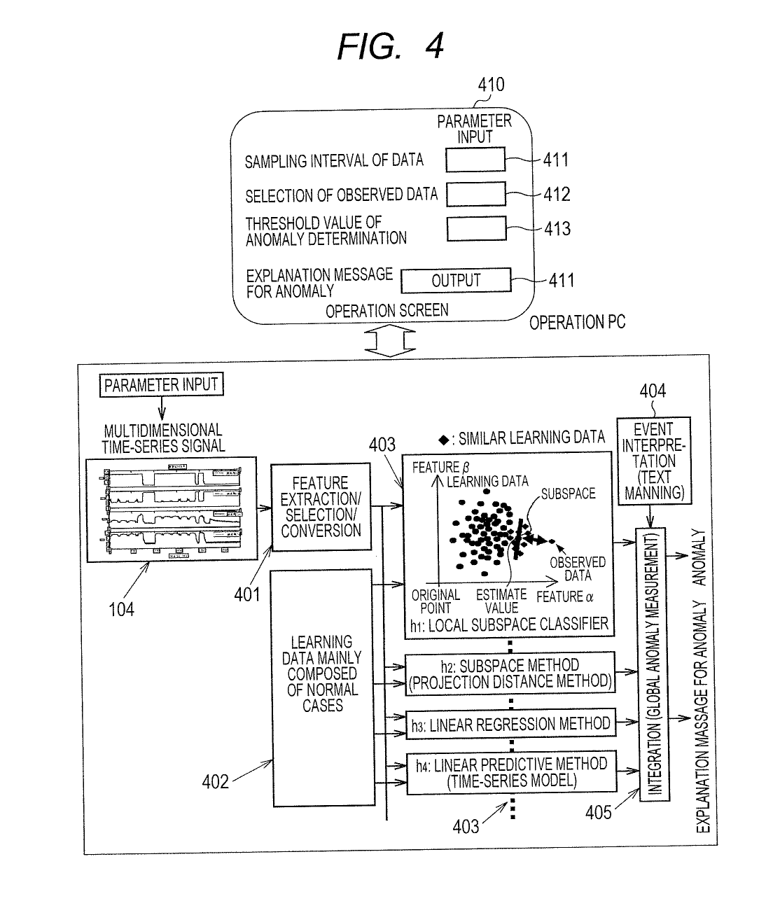

FIG. 4 shows an example-based anomaly detection method. In the anomaly detection, the dimension of the multidimensional time-series sensing data 104 is reduced by the feature extraction/selection/conversion unit 401, and the multidimensional time-series sensing data is classified by the plural classifiers of the classifier 305. Then, the global anomaly measurement is determined by executing a synthesis process (global anomaly measurement) 405 using the classified information and information 404 obtained by analyzing and interpreting the event data 105 by the analyzing unit 302 in the integration unit 306. Learning data 402 mainly composed of normal cases is classified by the plural classifiers 305 to be used for the determination 405 of the global anomaly measurement. In addition, the learning data 402 itself mainly composed of normal cases is selected, and is accumulated and updated to improve the accuracy.

FIG. 4 illustrates an input/output screen 410 on an operation PC into which a user inputs parameters. The parameters input by the user are a data sampling interval 411, observed data selection 412, and an anomaly determination threshold value 413. The data sampling interval 411 is used to instruct, for example, how often data is obtained. The observed data selection 412 is used to instruct which sensor signal is mainly used. The anomaly determination threshold value 413 is a threshold value to digitalize values of anomalies expressed as the calculated deviation/departure, outlier, divergence degree, and anomaly measurement from the model. Further, a message 414 related to anomalies obtained by executing the integration process 405 and determining the global anomaly measurement is output to the input/output screen 410.

Plural classifiers shown in FIG. 4 are provided with some classifiers (h1, h2, , , , ) in the classifying unit 305 of FIG. 3, and these are decided (fused 405) by a majority. Specifically, ensemble (group) learning using a different group of classifiers (h1, h2, , , , ) can be applied. For example, the first classifier can be applied to a projection distance method, the second classifier can be applied to a local subspace classifier, and the third classifier can be applied to a linear regression method. An arbitrary classifier can be applied if it is based on case data.

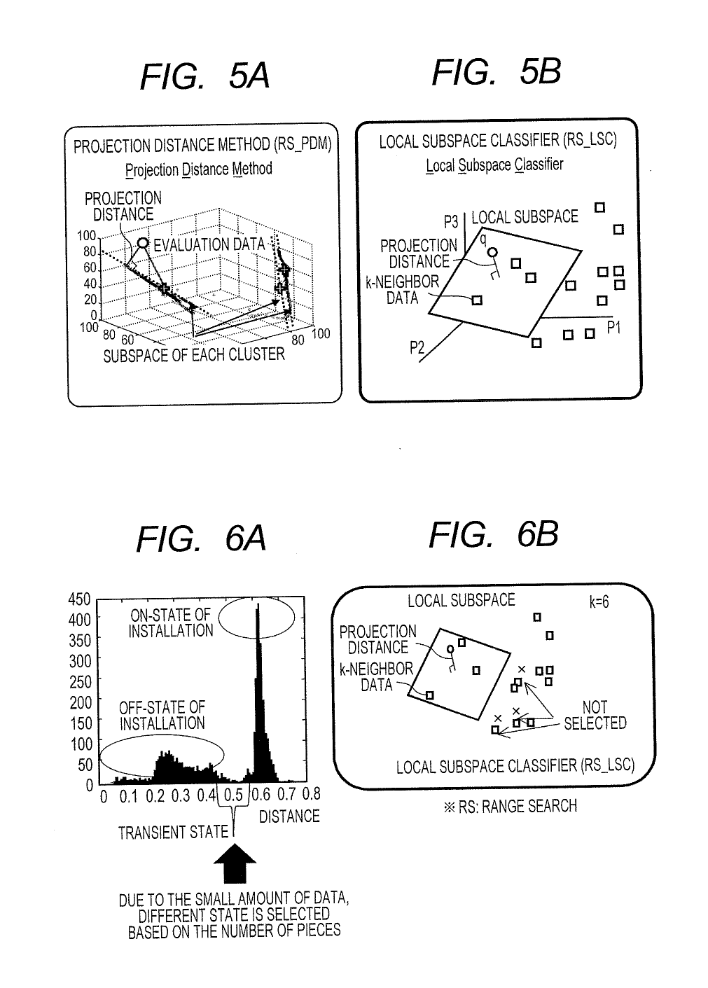

FIG. 5A and FIG. 5B show an example of a classifying method in the classifying unit 305. FIG. 5A shows the projection distance method. The projection distance method is a method in which the learning data is classified by a projection distance to a near subspace, namely, a deviation from a model is obtained. In general, eigenvalue decomposition is performed for the autocorrelation matrix of data of each class (category), and an eigenvector is obtained as a base. Eigenvectors corresponding to some of top larger eigenvalues are used. When an unknown pattern q (latest observed pattern) is input, the length of orthogonal projection to a subspace, or a projection distance to a subspace is obtained. A normal part of the multidimensional time-series signal is basically targeted, and thus a distance from the unknown pattern q (latest observed pattern) to a normal class is obtained to be used as a deviation (residual error). If the deviation is large, it is determined as a outlier. Even if the anomaly values are slightly mixed in such a subspace method, the dimension is reduced and the effects are eased at the time of forming the subspace. This is the merit obtained by applying the subspace method. A normal class is divided into plural classes in advance in consideration of the operation patterns of the installation. In this case, event information may be used, or may be executed by the clustering processing unit 303 of FIG. 3.

It should be noted that the centroid of each class is used as an original point in the projection distance method. An eigenvector obtained by applying Karhunen-Loeve expansion to the covariance matrix of each class is used as a base. Various subspace methods have been proposed. If a distance measure is provided, a misfit degree can be calculated. It should be noted that in the case of density, the misfit degree can be determined on the basis of the magnitude of density. The projection distance method corresponds to a similarity measure because the length of orthogonal projection is obtained.

As described above, the distance and similarity are calculated in a subspace to evaluate a misfit degree. Since the subspace method such as the projection distance method is a classifier based on a distance, metric learning can be used to learn vector quantization and a distance function for updating dictionary patterns as a learning method when anomaly data can be used.

FIG. 5B shows another example of a classifying method in the classifying unit 305. This method is referred to as a local subspace classifier. The local subspace classifier is a method of classifying based on a projection distance to the subspace in which data that is near in distance is expanded. In addition, k-pieces of multidimensional time-series signals near the unknown pattern q (latest observed pattern) are obtained, and a linear manifold is generated so that the nearest neighbor pattern of each class serves as an original point. In addition, the unknown pattern is classified into a class with the minimum projection distance to the linear manifold. The local subspace classifier is a type of subspace method. k is a parameter. In the anomaly detection, a distance from the unknown pattern q (latest observed pattern) to the normal class is obtained to be used as a deviation (residual error).

In this method, for example, a point obtained by orthogonal projection from the unknown pattern q (latest observed pattern) to a subspace formed using k pieces of multidimensional time-series signals can be calculated as an estimate value. Further, k pieces of multidimensional time-series signals are rearranged in the order near the unknown pattern q (latest observed pattern), and the estimate value of each signal can be calculated by weighting in reverse proportion to the distance. In the projection distance method or the like, the estimate value can be similarly calculated.

One type of parameter k is generally set. However, if some parameters k are used for execution, target data is selected in accordance with similarity, and comprehensive determination can be more effectively made from these results. Further, as shown in FIGS. 6A and 6B, in order to set an appropriate value of k for each observed data, learning data with a distance within a predetermined range from the observed data is selected, and the number of pieces of learning data is sequentially increased from the minimum number to the selective number, so that learning data with the minimum projection distance may be selected. This can be applied to the projection distance method.

Detailed procedures are as follows:
1. Distances between observed data and learning data are calculated and rearranged in ascending order.
2. Learning data with a distance d<th and the number of pieces of which is k or smaller is selected.
3. A projection distance is calculated in a range of j=1 to k and the minimum value is output.

Here, the threshold value th is experimentally determined from the frequency distribution of distances.

The distribution in FIG. 6B represents the frequency distribution of distances of the learning data viewed from the observed data. In accordance with ON/OFF of the installation, the diphasic frequency distribution of distances of the learning data is shown in this example. The valley between two peaks represents a transient period from ON to OFF or from OFF to ON of the installation. This concept is referred to as a range search, and it is assumed that the range search is applied to selection of learning data.

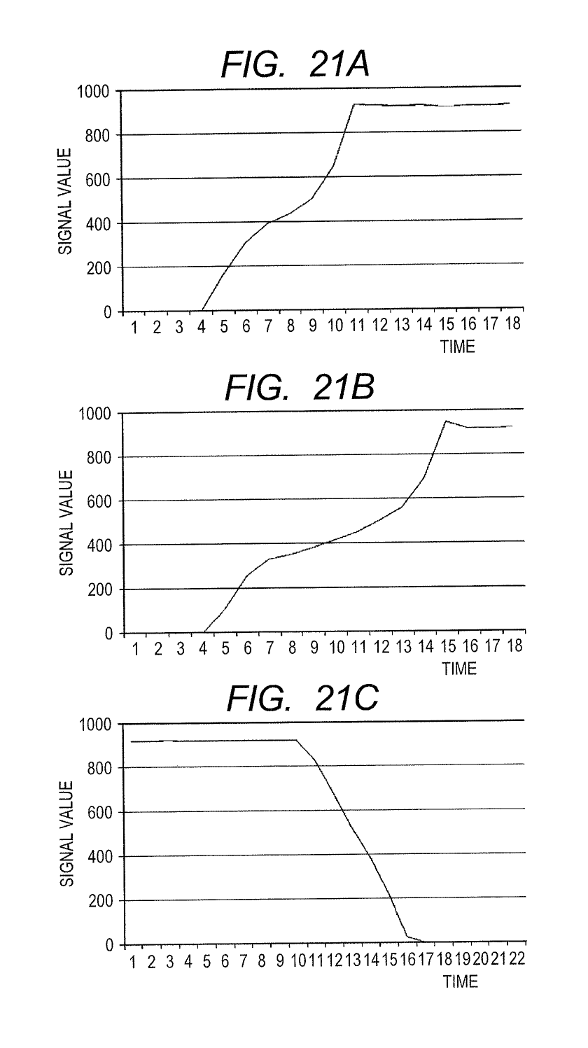

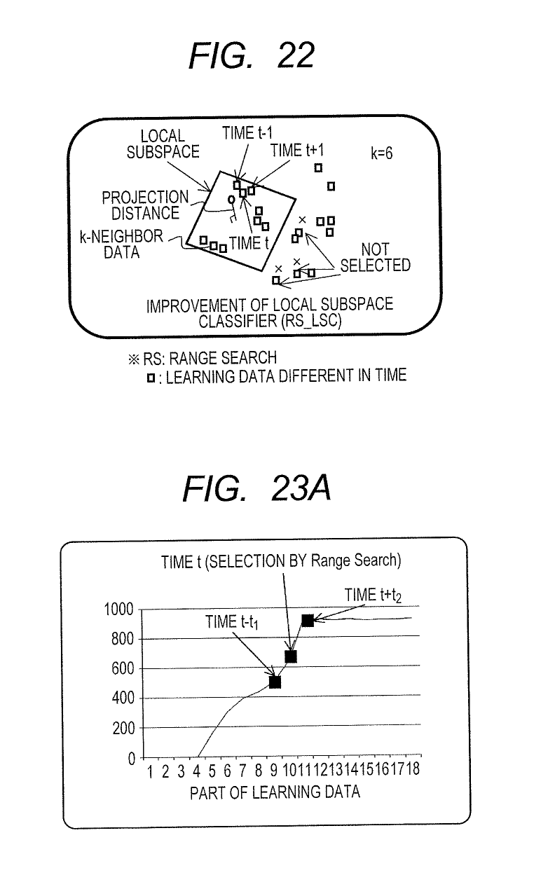

Further, an improvement of the range search will be described. FIGS. 21A and 21B show examples of rises of sensor signals, and FIG. 21C shows an example of a fall of a sensor signal. The horizontal axis represents time and the vertical axis represents a signal value. In a transient period such as a rise or fall of the sensor signal, the number of pieces of data is small. In addition, the waveform of the rise shown in FIG. 21A is different from that shown in FIG. 21B. Thus, the concept of the range search effectively works. Further, if the examples are examined in detail, it can be found that each signal is largely changed in the transient period. Although the values are obtained, the obtained signal values are largely changed due to a difference of sampling. A temporal positional shift occurs in sampling, and thus signal values before and after the selected learning data in time can be obtained. Thus, pieces of learning data at the time t−1 and time t+1 that are obtained before and after the time of the learning data represented by “learning data with a distance d<th and the number of pieces of which is k or smaller is selected” of the above-described procedure (2) are added to the learning data in the range search of the present invention. FIG. 22 shows this method. Specifically, in the method obtained by improving the local subspace classifier shown in FIG. 22, the followings are performed:

(1) Distances between observed data and learning data are calculated and rearranged in ascending order.
(2) Learning data with a distance d<th and the number of pieces of which is k or smaller is selected.
(3) Pieces of data that are obtained before and after the time of the selected learning data are added to the learning data.
(4) Projection distances are calculated within a range of j=1 to k and the minimum value is output.

Here, the threshold value th is experimentally determined from the frequency distribution of distances.

By improving the range search, a correct value can be obtained even in the transient period in the anomaly measurement, and high reliability can be secured. It should be noted that the number of pieces of learning data exceeds k as a result. In addition, k is a provisional number, and it may be determined based only on “distance d<th”.

However, it is important to always correlate previous and subsequent learning data in time other than the selected data. In other words, the pieces of learning data are continued in time. When the learning data is selected in accordance with the observed data, the previous and subsequent pieces of data are added.

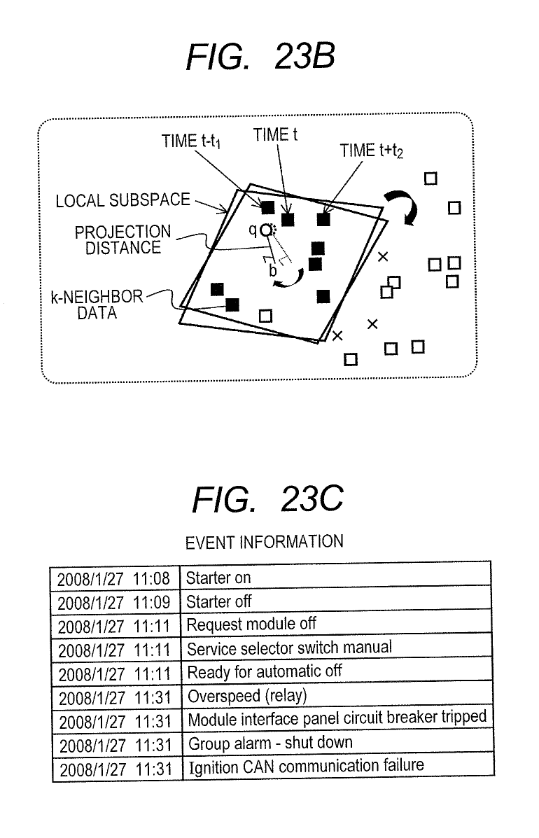

An extended example thereof is shown in each of FIGS. 23A to 23C. In the example, the pieces of learning data at the time t−1 and time t+1 that are obtained before and after the time of the selected learning data are not used, but which time of data is selected is determined on the basis of the event information. Specifically, the example is a method of generating learning data close in time and space in which previous and subsequent pieces of data in time are added to the learning data based on the event information in consideration of the small number of data in the transient state, and the learning data is generated on the basis of the similarity between the distances and time. In FIG. 23A, pieces of learning data at the time t−t1 and the time t+t2 that are close in time to the selected data at the time t are added along the signal waveform.

FIG. 23B shows a state of changes of subspaces when a local subspace is obtained using data between the time t−t1 and the time t+t2 for a local subspace obtained using k-neighbor data. In the example, two pieces of learning data are added. However, more pieces of learning data are possibly selected on the basis of the event information shown in FIG. 23C. The event information in this case is information representing the state of the installation, for example, an event in which the speed (number of revolutions) of an engine has reached a certain value, or a subsequent event such as a synchronous instruction to a power generator.

It should be noted that even if the anomaly values are slightly mixed in the local subspace classifier, the influence is considerably eased at the time of forming the local subspace.

It should be noted that the centroid of the k-neighbor data is defined as a local subspace in the classification called as an LAC (Local Average classifier) method (not shown). Further, a distance b from the unknown pattern q (latest observed pattern) to the centroid is obtained to be used as a deviation (residual error).

An example of the classifying method in plural classifiers in the classifying unit 305 shown in FIG. 5 is provided as a program.

It should be noted that if simply regarded as an issue of one class classification, a classifier such as a one class support vector machine can be applied. In this case, Radial Basis Function Kernel mapping to a high-dimensional space can be used. In the one class support vector machine, values near the original point are outliers, namely, anomalies. It should be noted that the support vector machine can be adapted to the high dimension of feature amounts. However, if the number of pieces of learning data is increased, the amount of calculations is disadvantageously enormously increased.

Therefore, a method such as “IS-2-10, Takekazu KATO, Mami NOGUCHI, Toshikazu WADA (Wakayama University), Kaoru SAKAI, Syunji MAEDA (Hitachi, Ltd.); one class classifier based on accessibility of patterns” presented in MIRU2007 (Meeting on Image Recognition and Understanding 2007) can be applied. In this case, if the number of pieces of learning data is increased, it is advantageous in that the amount of calculations is not enormously increased.

As another method of recognizing patterns, a mutual subspace method is known. For example, a method with tolerance to changes of patterns is known as described in Non patent Literature 2. In this method, an input pattern is represented using a subspace as similar to the dictionary side, and the similarity is represented by cos θ using an angle θ formed by the subspace of the input pattern and that on the dictionary side.

In addition, as another usage method of the mutual subspace method, the method described in Patent Literature 4 is known. In the method, the face of a person is recognized in such a manner that in consideration of the effects of changes such as the direction of the face, changes in facial expression, changes in illumination, and secular changes, projection to a certain subspace is performed to reduce the sensitivity in the direction and the effects of changes are eased.

In the case where there are many patterns of observed values, the subspace method can be applied to an issue of obtaining the similarity between the learning data (plural pieces of data) and the observed data (plural pieces of data).

Specifically, the subspace method can be applied to an issue of the evaluation value of the learning data. For example, it is assumed that the learning data is used by updating the past one. In this case, it is essential to grasp the relation between the past learning data and the updated learning data. It is desired that the similarity be visually expressed to grasp the relation between the updated data and the past data.

The mutual subspace method is applied to the evaluation value between the pieces of learning data. Two pieces of data to be compared are represented using subspaces, and the similarity (angle θ formed by planes forming the subspaces of two pieces of data) or distance between the subspaces is obtained.

If the angle θ is small, the past learning data is similar to the updated learning data. On the other hand, if the angle θ is large, the past learning data is not similar to and is different from the updated learning data.

Thus, everytime the learning data is updated, a drawing in which the angle θ is illustrated can be shown and the updating process can be visually expressed.

In the present embodiment, it is assumed that a data flow is an important focus point because the time-series sensor data is used. Thus, it is assumed that the data flow is expressed using subspaces as an example.

In order to express the data flow using pieces of data that are obtained before and after the time of the focused observed data, the subspaces are generated. For the learning data (dictionary side), data close to the observed data is selected. The data is selected based on, for example, a distance. This method is referred to as a range search in this case. Then, pieces of data that are obtained before and after the time of the selected learning data are selected to generate the subspaces. It is assumed that the range search is extended to time and space. The angle formed by the subspaces of the observed data and the learning data is used as a measure of similarity.

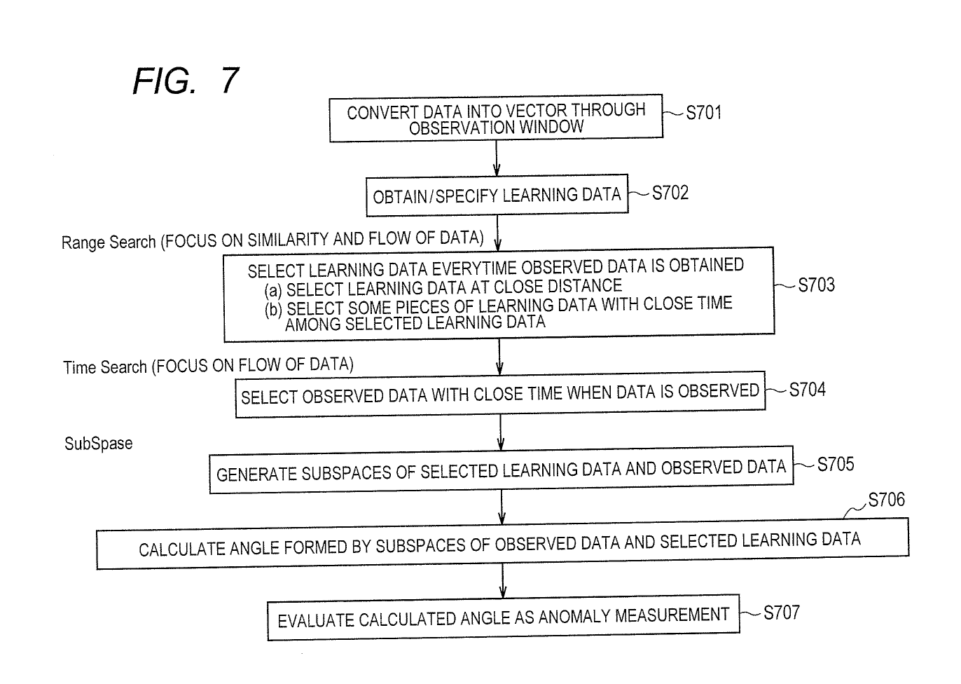

This procedure is shown in FIG. 7. In FIG. 7, the observed data obtained through an observation window is converted into a vector (S701). Next, the learning data is obtained or specified (S702), and then the learning data is selected by the range search focusing on the similarity and flow of data (S703). Specifically, everytime the observed data is obtained, (a) the learning data with a close distance is selected. Further, (b) some pieces of learning data that are close in time to the selected learning data are selected. In the procedure (b), the observed data at a time close to the data observation time is also selected by the time search focusing on the data flow (S704). Next, the subspace of each of the learning data and the observed data is generated (S705), and the angle formed by the generated subspaces of the learning data and the observed data is calculated (S706), and the calculated angle is evaluated as an anomaly measurement (S7-7).

Although not illustrated in FIG. 7, feature conversion is performed for the data. Further, the data obtained through the observation window is converted into a vector. Further, the data is normalized (canonicalized) and whitened if needed. It should be noted that the distance and time used in the range search are parameters, and are provided in advance.

The above-explained method is similar to the mutual subspace method, but different from it in that the data flow of the observed data is represented using the small number of dimensions and is represented as the subspace. Therefore, a time stamp is provided, and not only the observed data, but also the learning data is managed using the time information. Then, data is selected in a designated time range, and is represented using a low-dimensional subspace so as to express a motion as a vector, such as which direction of the feature space the selected data faces or how fast the selected data is moving. The data may be directly expressed by a vector.

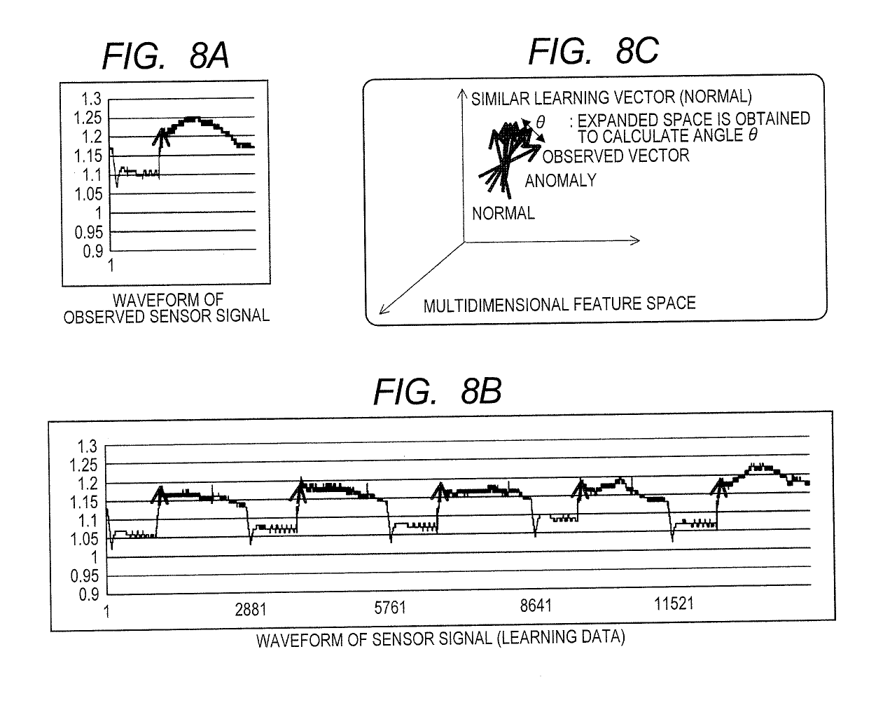

FIGS. 8A, 8B and 8C show an example of detecting an anomaly while focusing on a motion vector.

FIG. 8A shows an observed waveform signal. FIG. 8B shows detected previous and subsequent waveform signals of the observed waveform signal obtained as learning data. The arrows a1, a2, a3, a4, and a5 shown in FIG. 8B are data corresponding to the arrow b0 shown in FIG. 8A, Further, FIG. 8C is a diagram in which pieces of data close in distance to the arrow b0 of the observed data of FIG. 8A and the arrow b0 of the learning data of FIG. 8B in a feature space are represented by vectors in a multidimensional feature space. The angle θ formed by a resultant vector C0 obtained by combining vectors (similar learning vectors) formed using the learning data and a vector (observed vector) B0 formed using the observed data is calculated, and the calculated angle can be evaluated as an anomaly measurement.

As described above, the multidimensional time-series signals are expressed with a low-dimensional model, so that a complicated state can be decomposed and can be expressed with a simple model. Accordingly, the phenomena can be advantageously easily understood. Further, since the model is set, it is not necessary to completely prepare data as the method disclosed in Patent Literature 1.

FIG. 9 shows an example of feature conversion 900 in which the dimension of the multidimensional time-series signals 104 used in FIG. 3 is reduced. Other than a principal component analysis 901, some methods such as an independent component analysis 902, a non-negative matrix factorization 903, a projection to latent structure 904, and a canonical correlation analysis 905 can be applied. FIG. 9 shows a method diagram 910 and a function 920 together.

The principal component analysis 901 is referred to as PCA, and M-dimensional multidimensional time-series signals are linearly converted into r-dimensional multidimensional time-series signals to generate an axis with the maximum variation. Karhunen-Loeve conversion may be used. The number of dimensions r is determined on the basis of a value as a cumulative contribution ratio obtained in such a manner that eigenvalues obtained by the principal component analysis 901 are arranged in descending order and the sum of some larger eigenvalues is divided by the sum of the all eigenvalues.

The independent component analysis 902 is referred to as ICA, and is effective as a method of exposing non-gaussian. The non-negative matrix factorization 903 is referred to as NMF, and a sensor signal expressed in a matrix format is decomposed into non-negative components. The methods with “unsupervised” are effective conversion methods in the case where the number of anomaly cases is small and the anomaly cases cannot be utilized as in the embodiment. In this case, an example of linear conversion is shown. However, non-linear conversion can also be applied.

The above-described feature conversions 900, including the canonicalization to normalize the standard deviation, is performed on the learning data and the observed data simultaneously. With this configuration, the learning data and the observed data can be handled in the same rank.

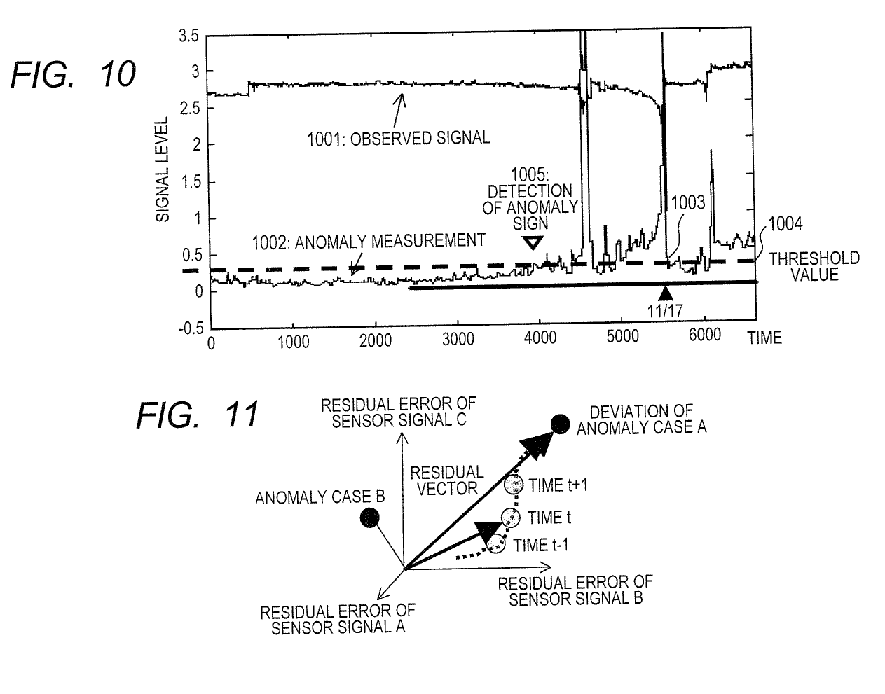

FIG. 10 shows an example of a detection result of an anomaly of a cooling water pressure as an example of anomaly detection by an example-based multivariate analysis targeted on a multidimensional sensor signal. The upper side of the drawing represents one of observed signals 1001, and the lower side thereof represents an anomaly measurement 1002 calculated by the multivariate analysis targeted on the multidimensional time-series sensor signal. FIG. 10 is an example in which the observed signal is gradually reduced, resulting in the halt of an installation 1003 on November 17. If the anomaly measurement 1002 is equal to or larger than a predetermined threshold value 1004 (or the anomaly measurement exceeds a threshold value the set number of times or more), it is determined as an anomaly. In the example, an anomaliesign 1005 can be detected before the halt of the installation 1003 on November 17, and appropriate countermeasures can be taken.

FIG. 11 is an explanatory view of a sign detection technique of occurrence of an anomaly of a cooling water pressure using residual patterns. FIG. 11 shows a method of calculating the similarity of the residual patterns. FIG. 11 is a diagram corresponding to the normal centroid 0 of each observed data obtained by the local subspace classifier and deviations (residual vectors or deviation vectors) from the normal centroid 0 of a sensor signal A, a sensor signal B, and a sensor signal C at times from the time t−1 to the time t+1 are expressed as trajectories in a space. Specifically, anomalies are expressed as residual vectors in FIG. 11, and an original point 0 is normal. In addition, the magnitude of each vector represents the degree of the anomaly, and the direction of each vector represents the type of anomaly. In FIG. 11, residual error series (transition of tip ends of the arrows of the residual vectors) of the observed data passing through the time t−1, time t, and time t+1 are represented by the dotted arrows.

Each similarity of the observed data and anomaly cases can be estimated by calculating the inner product (A·B) of each deviation. Further, the similarity can be estimated with an angle θ by dividing the inner product (A·B) by the size (norm). The similarity is obtained for the residual error patterns of the observed data, and anomalies predicted to occur are estimated by the trajectory of the obtained similarity.

Specifically, FIG. 11 shows deviations of anomaly cases A, B, and C. With reference to the deviation series pattern of the observed data represented by the dotted arrow, the anomaly is near the anomaly case B at the time t. However, not the anomaly case B but the anomaly case A can be predicted to occur from the trajectory of the deviation. In order to predict the anomaly case, deviation (residual error) time-series trajectory data before the occurrence of the anomaly case is stored into a database, and the similarity between the deviation (residual error) time-series pattern of the observed data and the time-series pattern of the trajectory data accumulated in the trajectory database is calculated, so that a sign of the occurrence of the anomaly can be detected.

If such a trajectory is displayed for a user on a GUI, the conditions of the occurrence of anomalies can be visually expressed and can be easily reflected on the countermeasures.

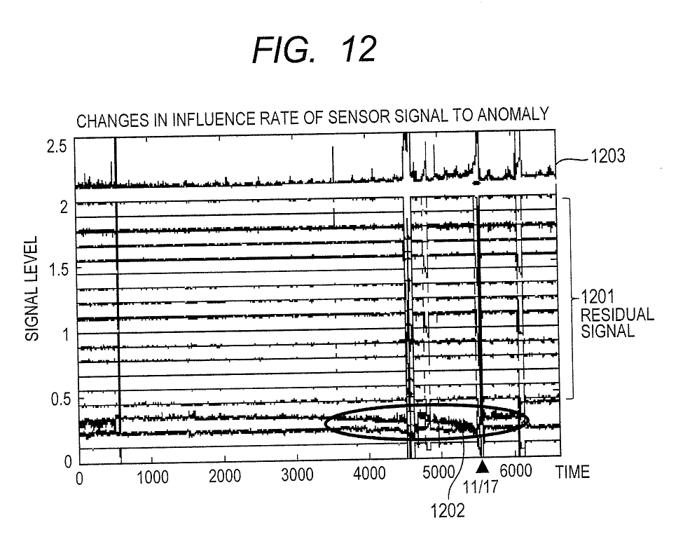

FIG. 12 shows temporal changes of deviation (residual) signals of plural pieces of observed data corresponding to the sensor signals A, B, C and the like of FIG. 11. In FIG. 11, for example, an anomaliesuch as a decrease in the cooling water pressure occurs on November 17. A residual signal 1202 is also significantly reduced, and it can be found that the anomaly of a decrease in the cooling water pressure can be visually grasped. Further, the residual signal 1201 of the observed data is always detected to be compared with time-series pattern examples of past trajectory data accumulated in a database of residual trajectories, and the similarity between the pieces of data is calculated, so that a sign of occurrence of a specific anomaly can be detected. In particular, it is possible to grasp which sensor exhibits an anomaliesimilar to that in the past. It should be noted that uppermost data 1203 of FIG. 12 is an anomaly measurement.

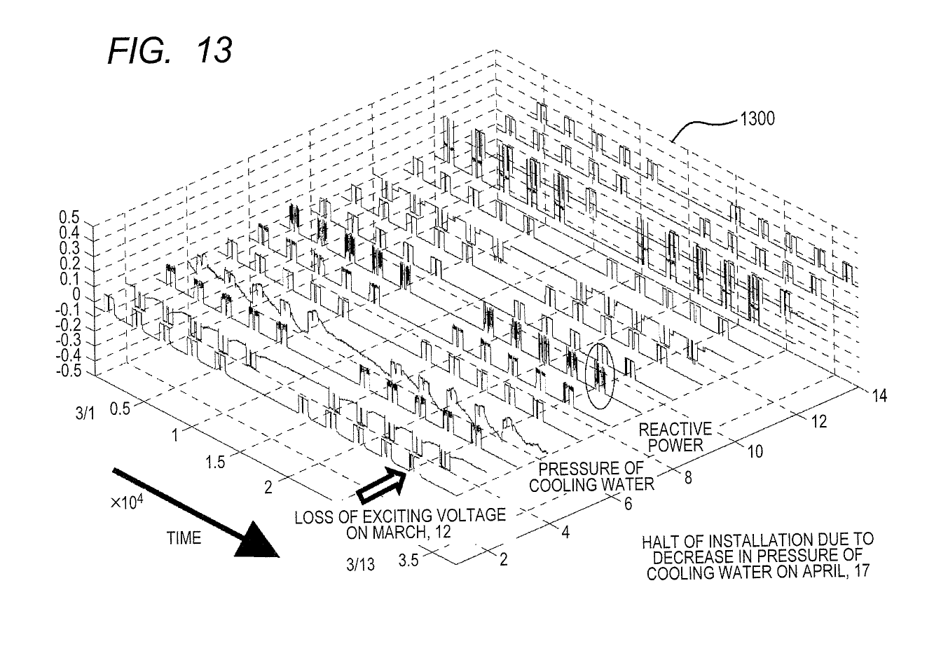

FIG. 13 shows a case of anomaly examples of a composite event. FIG. 13 illustrates multidimensional time-series sensor data 1300. An anomaly of a loss of exciting voltage occurs on March 12 and the installation is halted. Further, although not shown in FIG. 13, the installation is halted due to a decrease in the cooling water pressure on April 17, as another anomaly. The problem is that the anomaly of a loss of exciting voltage cannot be easily read from the multidimensional time-series sensor data 1300, and the anomaly of a decrease in the cooling water pressure causing the halt of the installation later cannot be exposed unless any process is performed.

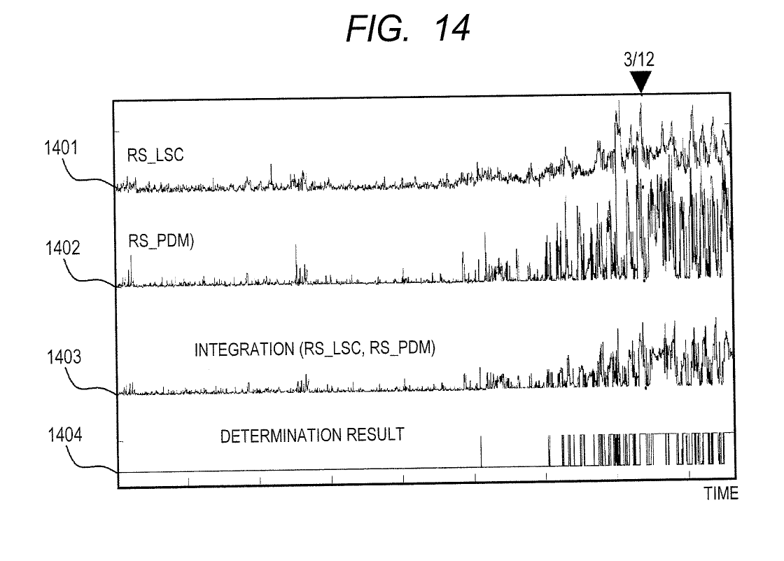

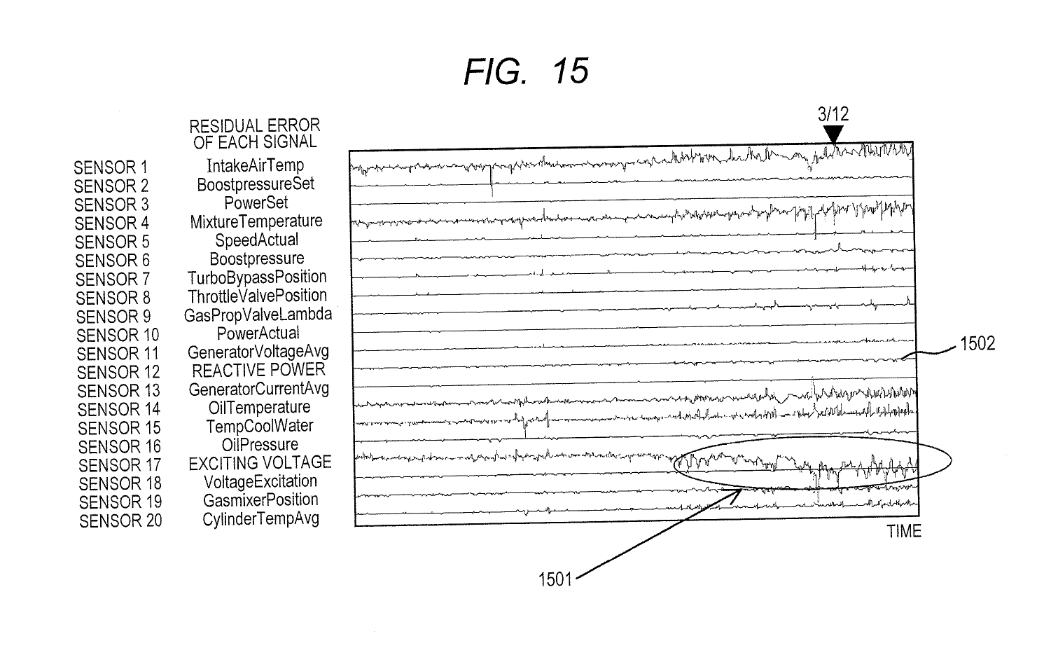

FIG. 14 shows a result of anomaly detection based on the subspace method. From the above of the drawing, shown are an anomaly measurement 1401 calculated by an RS_LSC method obtained by combining the Range Search method to the local subspace classifier LSC, an anomaly measurement 1402 calculated by an RS_PDM method obtained by combining the Range Search method to the projection distance method PDM, an anomaly measurement 1403 calculated by an integrated method obtained by integrating these methods, and a finally-digitalized determination result 1404. The anomaly measurement 1403 becomes large before March 12. As a result, it is likely to determine that the anomaly of a loss of exiting voltage has been quickly detected. However, it is not true in reality. The reason is shown in FIG. 15.

FIG. 15 shows residual signals of respective sensor signals from sensors 1 to n. FIG. 15 shows differences from the original point in the residual vectors shown in FIG. 14, and values are positive or negative. As being apparent from the drawing, a residual error 1501 of a decrease in the cooling water pressure detected by the sensor h is largely changed to a negative value on March 12. Specifically, it can be found that the residual error 1501 of a decrease in the cooling water pressure largely contributes to the anomaly measurement 1403 shown in FIG. 14. On the other hand, an anomaly of a loss of exiting voltage 1502 detected by the sensor i does not contribute to the anomaly measurement 1403.

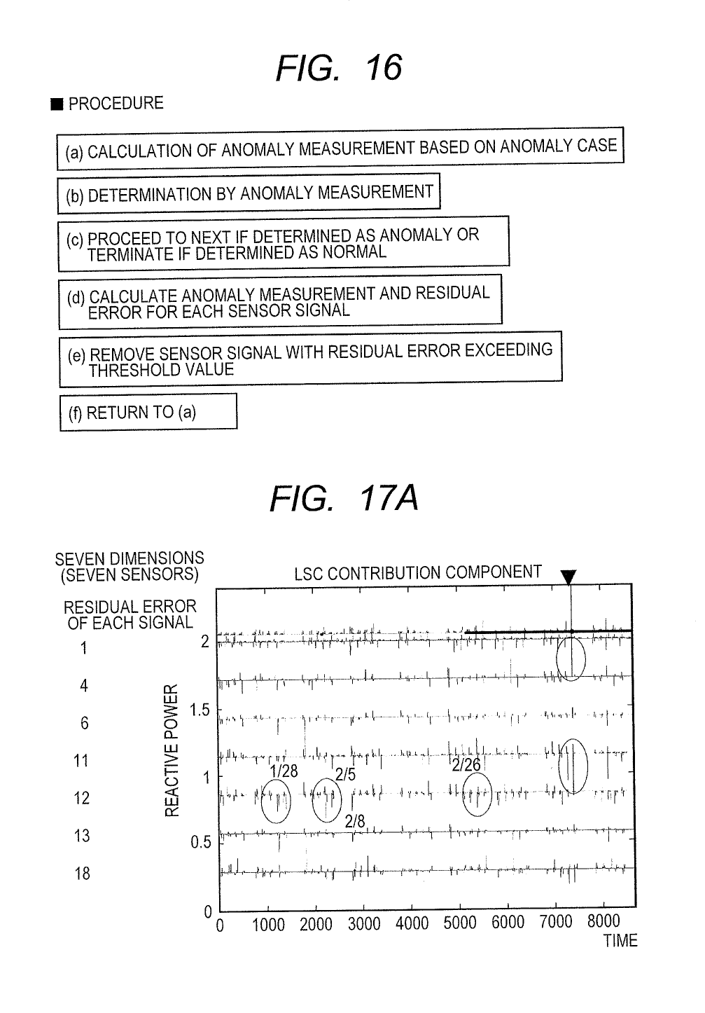

From these results, it can be found that the anomaly of a loss of exiting voltage that should have been detected was overlooked and the anomaly of a decrease in the cooling water pressure that would occur later was detected first in the determination result 1404 shown in FIG. 14. Countermeasures against such a problem are shown in FIG. 16.

The procedure thereof is shown in FIG. 16. An example of the most typical procedure is shown. First, (a) an anomaly measurement based on an anomaly case is calculated; (b) determination by the anomaly measurement is performed; (c) if it is determined as an anomaly (the anomaly measurement is equal to or larger than the threshold value), the procedure proceeds to the next, and if it is determined as a normal (the anomaly measurement is smaller than the threshold value), the procedure is terminated; (d) if it is determined as an anomaly, a residual error is calculated for each sensor signal; (e) the sensor signal with the residual error exceeding the threshold value is removed; and (f) the procedure returns to the start again to sequentially execute the processes from the process (a).

According to the procedure, the followings are repeated. After the anomaly measurement is calculated, the residual error is calculated; the sensor signal with a large residual error (the anomaly measurement of each sensor signal) is removed; and the anomaly measurement is calculated again. If the calculated anomaly measurement is smaller than the set threshold value, the process is terminated. The conditions of termination are set from an external I/F.

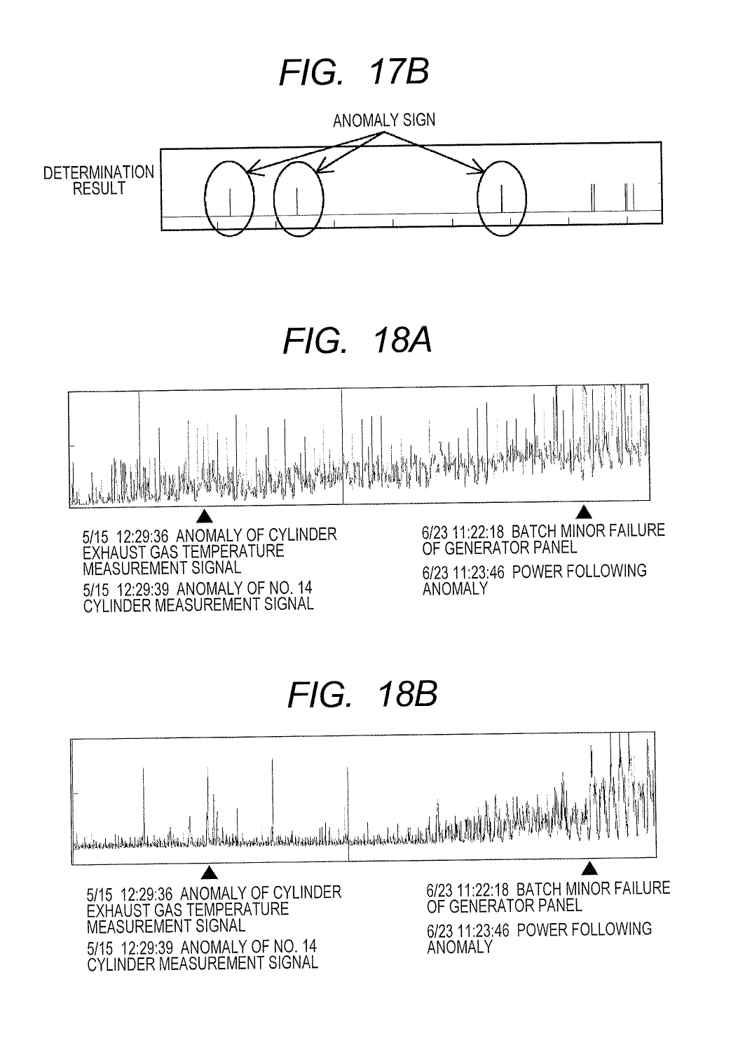

Removing the sensor signal is referred to as dimension reduction. A result obtained by applying a procedure of the dimension reduction is shown in each of FIGS. 17A and 17B.

FIG. 17A shows residual errors of respective sensor signals of seven dimensions reduced from the 20-dimensional signals, explained in FIG. 15, by mainly selecting electric-system sensor signals. It can be found that the sensor signal representing reactive power has extremely-large residual errors at the positions surrounded by the circle marks as a result of reducing the number (the number of dimensions) of sensor signals as described above, the sensor signal causing a loss of exiting voltage can be specified, and the anomaly of a loss of exiting voltage as an anomaliesign can be detected. FIG. 17B shows an example in which the anomaly measurement of reactive voltage with large residual errors is digitalized to determine an anomaly. It can be found that signs of anomalies are predicted at the positions surrounded by the circle marks.

In the example shown in FIG. 17A, the dimension reduction is sequentially performed from the viewpoint of the anomaly measurement, but may be performed from a different viewpoint. Other than the anomaly measurement, there are viewpoints such as phenomena, regions, relevance, statistical nature, physical nature (design standards), or combinations thereof. The viewpoints can be separated depending on a difference in attribution such as a pressure, temperature, and the number of revolutions, or such as an electrical system or mechanical system. In addition, the viewpoints can be separated depending on a difference in the responsiveness of the sensor signal or a time constant. As stated above, the dimension reduction is sequentially performed. Furthermore, the dimension reduction may be performed by classifying the sensor signals into some groups. In this case, the anomaly measurement may be calculated by selecting a group, or the anomaly measurement may be calculated for each group in parallel. It is obvious that the anomaly measurement may be calculated for a selected group.

It should be noted that the sensor signal data may be normalized in advance. The normalization means, for example, adjusting the maximum value and the minimum value between pieces of sensor signal data. Alternatively, the standard deviation of each sensor signal data may be obtained and adjusted to 1. As described above, the amplitude of the sensor signal data is adjusted.

As another preprocessing method, a different weight may be given to the sensor signal data. A weight is given to the sensor signal data by the normalization/feature extraction/selection/conversion unit 12 shown in FIG. 3. The amplitude of the sensor signal data is changed by design on the basis of a physical study. A large weight is given to the sensor signal data insensitive to failures, and a small weight is given to the sensor signal data sensitive to failures. Accordingly, advantages and disadvantages in detection are eliminated to comprehensively detect anomalies. The values of these weights are set by an external I/F.

Next, effects obtained by applying the Range Search method when selecting the learning data will be shown.

FIGS. 18A and 18B show examples in which anomaly detection was performed for an installation whose operation was not steady and whose operation patterns are plural. The sensor data can represent a transient period from the ON-state of operations to the OFF-state of operations, or a transient period from the OFF-state of operations to the ON-state of operations. In the case of a gas engine, the sensor data can represent changes in the state due to switching of a fuel or changes in operation patterns due to variation of a load. In the case of such a sensor signal, FIG. 18A shows a result of a method of selecting the maximum value and the minimum value of a certain section of each sensor signal as learning data, and FIG. 18B shows a result of applying the Range Search method. According to FIG. 18B, it can be found that the anomaly measurement is stabilized by applying the Range Search method.

As being apparent from the comparison between FIG. 18A and FIG. 18B, in the case where the maximum value and the minimum value of a certain section of each sensor signal are selected as learning data as in FIG. 18A, false information is increased. On the contrary, in the case where the similar data is selected as learning data as in FIG. 18B, it can be found that false information is largely decreased. It can be conceived that this is because the anomaly measurement increasing in a spike manner is decreased by selecting the similar data as learning data.

FIG. 19 shows a hardware configuration of a anomaly detection system 25 of the present invention. The sensor data of a targeted engine is input to a processor 119 for detecting anomalies, and is stored into a database DB121 after a missing value is restored. The processor 119 includes the configuration described in FIG. 3 and detects anomalies using the obtained observed sensor data stored in the database DB121 and DB data composed of learning data. Various kind of information is displayed on a display unit 120, and the presence or absence of anomaliesignals or an explanation message for an anomaly described below is output. A trend can be displayed. An interpretation result of an event can be displayed.

Other than the hardware, a program installed in the hardware can be provided to customers through media or on-line services.

The DB of the database DB121 can be operated by skilled engineers. Especially, the DB can teach and store anomaly cases and cases of countermeasures. (1) Learning data (normal), (2) anomaly data, and (3) content of countermeasures are stored. Since the database is structured so that skilled engineers can edit, a sophisticated and useful database can be completed. Further, data is operated by automatically moving the learning data (each data and the position of the centroid) along with the occurrence of an alarm and part replacement. Further, the obtained data can be automatically added. If there is anomaly data, a method of general vector quantization can be applied when data is moved. Further, the trajectories of the past anomaly cases A and B described in FIG. 13 are stored in the database DB121, and the type of anomaly is specified (diagnosed) by checking against these trajectories. In this case, the trajectories are expressed and stored as data in an N-dimensional space.

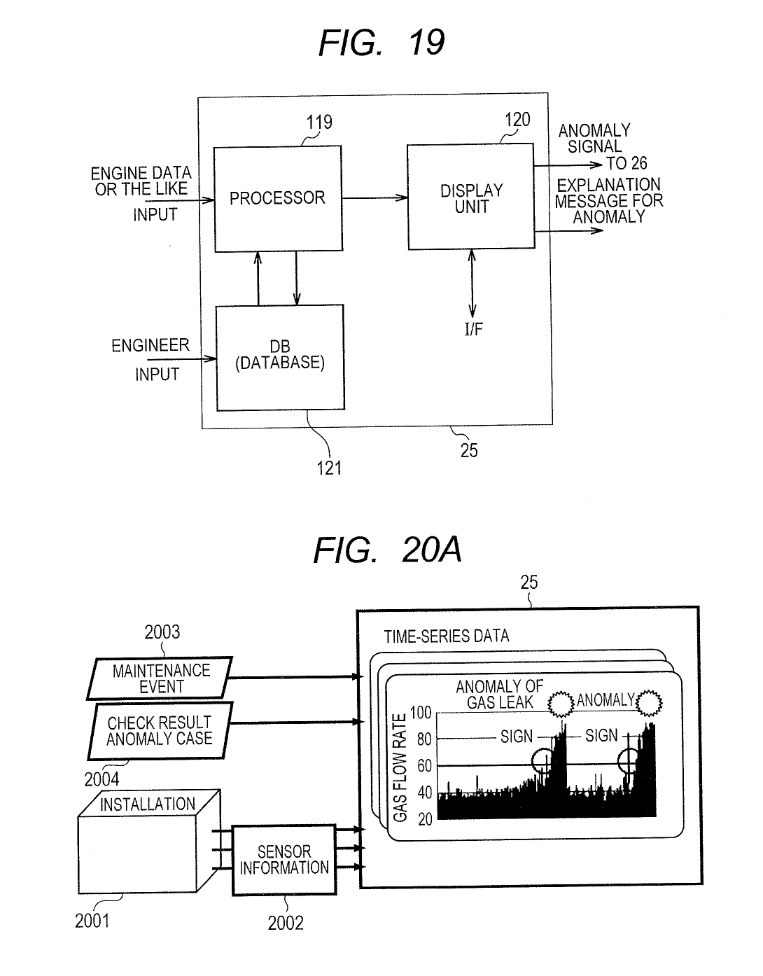

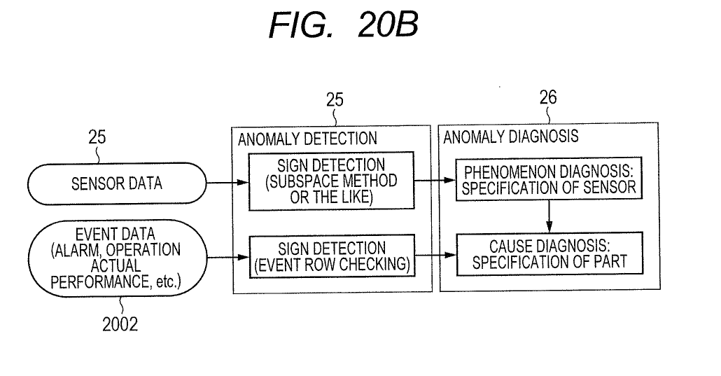

FIG. 20A shows anomaly detection performed by the anomaly detection system 25 and a diagnosis after the anomaly detection. In FIG. 20, the time-series signal as sensor information 2002 is input from an installation 2001 to perform feature extraction/classification of the time-series signal with the anomaly detection system 25, so that anomalies are detected. The number of installations 2001 is not limited to one. Plural installations may be targeted. Additional information such as the event 2003 (an alarm, operation actual performance, and the like, more particularly, such as start and halt of the installation, settings of operation conditions, various breakdown information, various alarm information, regular check information, operation environments such as setting temperatures, operation accumulated time, part replacement information, adjustment information, and cleaning information) of maintenance of each installation, and past information such as an anomaly case 2004 of an inspection result are extracted to detect anomalies with high sensitivity.

As shown in FIG. 20B, if an anomaly can be quickly detected as a sign by the anomaly detection system 25, some countermeasures can be taken before the installation is broken and the operation is halted. Further, a sign is detected by the subspace method, it is comprehensively determined whether or not the sign is a sign of an anomaly while additionally performing event row checking, an anomaly diagnosis is made on the basis of the sign, a breakdown part candidate is specified, and it is estimated when the part is broken to halt the installation. Then, necessary parts for replace are arranged at necessary timing.

A anomaly diagnosing system 26 can be easily understood by being divided into a phenomenon diagnosing unit that specifies a sensor with a sign and a cause diagnosing unit that specifies a part that possibly causes breakdown. The anomaly detection system 25 outputs information related to the feature amounts as well as a signal indicating the presence or absence of an anomaly to the anomaly diagnosing system 26. On the basis of the information, the anomaly diagnosing system 26 carries out a diagnosis.

Comprehensive effects of some embodiments will be further described. For example, a company having a power-generation installation desires to reduce maintenance costs for devices, and the devices are checked or parts are replaced within the warranty period. This is called time-based installation maintenance.

However, the time-based maintenance is recently being shifted to state-based maintenance in which parts are replaced by checking the state of the device. In order to conduct the state-based maintenance, it is necessary to collect normal/anomaly data of the device, and the quantity and quality of the data determine the quality of the state-based maintenance. However, the collection of anomaly data is rare in many cases. As the size of an installation increases, it becomes difficult to collect anomaly data. Thus, it is important to detect a outlier from the normal data. According to some embodiments described above, there are direct effects such as: (1) an anomaly can be detected from normal data; (2) if the collection of data is imperfect, anomaly detection can be performed with a high degree of accuracy; and (3) if anomaly data is contained, the effects can be accepted. In addition, there are secondary effects such as: (4) a user can visually grasp an anomaly phenomenon, and the phenomenon can be easily understood; (5) a designer can visually grasp an anomaly phenomenon, and the anomaly phenomenon can be easily associated with a physical phenomenon; (6) knowledge of an engineer can be used; (7) a physical model can be used together; and (8) an anomaly detection method with a large operation load and a long processing time required can be installed and applied. In addition, (9) according to the detection method, the learning data can be freely added. The pieces of learning data that are high in similarity can be deleted. Accordingly, the intension of a user can be feely reflected.

### INDUSTRIAL APPLICABILITY

The present invention can be used as anomaly detection for a plant or an installation.

### REFERENCE SINGS LIST

11 . . . multidimensional time-series signal
12 . . . feature extraction/selection/conversion unit
13 . . . classifier
14 . . . fusion (that integrates outputs of some classifiers and outputs a global anomaly measurement)
15 . . . learning database (that selects learning data) mainly composed of normal cases
16 . . . clustering
24 . . . feature extraction/classification of time-series signals
25 . . . anomaly detection system
26 . . . anomaly diagnosing system
119 . . . processor
120 . . . display unit
121 . . . database (DB)
301 . . . weight/normalization/feature extraction/selection/conversion unit
302 . . . mode analyzing unit
303 . . . clustering processing unit
304 . . . learning data selection unit
305 . . . classifying unit
306 . . . integration unit
307 . . . verification evaluating unit

1. An anomaly detection method for detecting an anomaly of a plant or an installation, comprising the steps of:
obtaining data related to an operation state of the plant or the installation from plural sensors installed at the plant or the installation;
modeling learning data corresponding to nearly-normal data in a normal operation state of the plant or the installation;
calculating anomaly measurement of each data obtained from the plural sensors by using the modeled learning data; and
detecting an anomaly of the plant or the installation on the basis of the calculated anomaly measurement,
wherein in the step of calculating anomaly measurement, residual errors from the modeled learning data are obtained for the pieces of data obtained from the plural sensors, a signal having the residual error larger than a predetermined value is removed, and
wherein in the step of detecting an anomaly, anomaly detection is performed by recursively calculating the anomaly measurement for the data obtained from the plural sensors from which the signal having the large residual error is removed.

2. The anomaly detection method according to claim 1, wherein in the step of modeling, signals from the plural sensors are normalized in advance.

3. The anomaly detection method according to claim 1, wherein in the step of modeling, a predetermined weight is given to each sensor signal.

4. The anomaly detection method according to claim 1, wherein in the step of modeling, the learning data is modeled using that similar to the nearly-normal data in a normal operation state of the plant or the installation.

5. The anomaly detection method according to claim 4, wherein in the step of modeling, the learning data is modeled using that closer in distance and/or time to the nearly-normal data in a normal operation state of the plant or the installation.

6. A anomaly detection method for detecting an anomaly of a plant or an installation, comprising the steps of:
obtaining data related to an operation state of the plant or the installation from plural sensors installed at the plant or the installation;
modeling learning data corresponding to nearly-normal data in a normal operation state of the plant or the installation;
calculating anomaly measurement of each data obtained from the plural sensors by using the modeled learning data; and
detecting an anomaly of the plant or the installation on the basis of the calculated anomaly measurement,
wherein in the step of calculating anomaly measurement, residual errors from the modeled learning data are obtained for the pieces of data obtained from the plural sensors, a region to which a signal having the residual error larger than a predetermined value belongs or a signal belonging to the same category in terms of a function is removed, and
wherein in the step of detecting, anomaly detection is performed by recursively calculating the anomaly measurement for the data obtained from the plural sensors from which the signal having the large residual error is removed.

7. The anomaly detection method according to claim 6, wherein in the step of modeling, a sensor signal is normalized in advance.

8. The anomaly detection method according to claim 6, wherein in the step of modeling, a predetermined weight is given to each sensor signal.

9. The anomaly detection method according to claim 6, wherein in the step of modeling, the learning data is modeled using that similar to the nearly-normal data in a normal operation state of the plant or the installation.

10. The anomaly detection method according to claim 9, wherein in the step of modeling, the learning data is modeled using that closer in distance and/or time to the nearly-normal data in a normal operation state of the plant or the installation.

11. An anomaly detection system for detecting an anomaly of a plant or an installation, the system comprising:
a sensor data obtaining unit that obtains data related to an operation state of the plant or the installation from plural sensors installed at the plant or the installation;
a learning data modeling unit that models learning data corresponding to nearly-normal data in a normal operation state of the plant or the installation obtained from the sensor data obtaining unit;
an anomaly measurement calculating unit that calculates the anomaly measurement of each data obtained from the plural sensors using the learning data modeled by the learning data modeling unit; and
an anomaly detecting unit that detects an anomaly of the plant or the installation on the basis of the anomaly measurement calculated by the anomaly measurement calculating unit,
wherein the anomaly measurement calculating unit obtains residual errors from the modeled learning data for the pieces of data from the plural sensors obtained by the sensor data obtaining unit, removes a signal having the residual error larger than a predetermined value, and
wherein the anomaly detecting unit performs anomaly detection by recursively calculating the anomaly measurement for the data obtained from the plural sensors from which the signal having the large residual error is removed.

12. The anomaly detection system according to claim 11, wherein a signal from the sensor is normalized in advance.

13. The anomaly detection system according to claim 11, wherein in the learning data modeling unit, a predetermined weight is given to each sensor signal.

14. The anomaly detection system according to claim 11, wherein the modeling unit models the learning data using that similar to the nearly-normal data in a normal operation state of the plant or the installation.

15. The anomaly detection system according to claim 14, wherein the modeling unit models the learning data using that closer in distance and/or time to the nearly-normal data in a normal operation state of the plant or the installation.

16. An anomaly detection system for detecting an anomaly of a plant or an installation, the system comprising:
a sensor data obtaining unit that obtains data related to an operation state of the plant or the installation from plural sensors installed at the plant or the installation;
a learning data modeling unit that models learning data corresponding to nearly-normal data in a normal operation state of the plant or the installation obtained from the sensor data obtaining unit;
an anomaly measurement calculating unit that calculates the anomaly measurement of each data obtained from the plural sensors using the learning data modeled by the learning data modeling unit; and
an anomaly detecting unit that detects an anomaly of the plant or the installation on the basis of the anomaly measurement calculated by the anomaly measurement calculating unit,
wherein the anomaly measurement calculating unit obtains residual errors from the model for the pieces of data from the plural sensors obtained by the sensor data obtaining unit, removes a region to which a signal having the residual error larger than a predetermined value belongs or a signal belonging to the same category in terms of a function, and
wherein the anomaly detection unit performs anomaly detection by recursively calculating the anomaly measurement for the data obtained from the plural sensors from which the signal having the large residual error is removed.

17. The anomaly detection system according to claim 16, wherein in the anomaly measurement calculating unit, a sensor signal is normalized in advance.

18. The anomaly detection system according to claim 16, wherein in the anomaly measurement calculating unit, a predetermined weight is given to each sensor signal.

19. The anomaly detection system according to claim 16, wherein the modeling unit models the learning data using that similar to the nearly-normal data in a normal operation state of the plant or the installation.

20. The anomaly detection system according to claim 19, wherein the modeling unit models the learning data using that closer in distance and/or time to the nearly-normal data in a normal operation state of the plant or the installation.

21. A anomaly detection method, comprising the steps of:
setting targets of observed data with an attribute of time related to an operation state of a plant or an installation from plural sensors installed at the plant or the installation and learning data corresponding to nearly-normal data in a normal operation state of the plant or the installation;
expressing a motion of the observed data by a motion vector in a feature space;
selecting a learning data closer in distance to the observed data;
expressing a motion of the selected learning data by a motion vector; and
comparing an angle formed by the motion vector of the observed data and the motion vector of the learning data to a predetermined value to detect an anomaly.

22. An anomaly detection method, comprising the steps of:
setting a target of observed data with an attribute of time related to an operation state of a plant or an installation from plural sensors installed at the plant or the installation and learning data corresponding to nearly-normal data in a normal operation state of the plant or the installation;
selecting selected learning data from the learning data, one closer in distance to the observed data and the other closer in time to the one closer in distance in a feature space;
modeling the selected learning data;
selecting data closer in time to the observed data, modeling the observed data and the selected data closer in time, and calculating similarity among the modeled learning data, the modeled observed data, and the selected data closer in time; and
detecting anomaly on the basis of the calculated similarity.

23. An anomaly detection method, comprising the steps of:
setting targets of observed data with an attribute of time related to an operation state of a plant or an installation from plural sensors installed at the plant or the installation and learning data corresponding to nearly-normal data in a normal operation state of the plant or the installation;
selecting selected learning data from the learning data, one closer in distance to the observed data and the other closer in time to the one closer in distance in a feature space;
modeling the selected learning data in a low-dimensional subspace;
selecting data closer in time to the observed data and modeling the observed data and the selected data closer in time in the low-dimensional subspace;
calculating similarity among the subspaces of the modeled learning data, the modeled observed data, and the modeled selected-data closer in time; and
detecting anomaly using information of the calculated similarity of the subspaces.

24. An anomaly detection system, comprising:
input means that inputs observed data with an attribute of time related to an operation state of a plant or an installation from plural sensors installed at the plant or the installation;
learning data selecting means that, of learning data corresponding to nearly-normal data in a normal operation state of the plant or the installation, selects one closer in distance to the observed data;
vectorization means that expresses the motion of the observed data input by the input means using a motion vector in a feature space and the motion of the learning data selected by the learning data selecting means using a vector; and
anomaly detecting means that detects an anomaly by comparing an angle formed by the motion vector of the observed data vectorized by the vectorization means and that of the learning data with a predetermined value.

25. An anomaly detection system, comprising:
input means that inputs observed data with an attribute of time related to an operation state of a plant or an installation from plural sensors installed at the plant or the installation;
learning data selecting means that, of learning data corresponding to nearly-normal data in a normal operation state of the plant or the installation, selects one closer in distance to the observed data and the other closer in time to the one closer in distance;
modeling means that models the learning data selected by the learning data selecting means and selects data closer in time to the observed data input by the input means to model the observed data and the selected data closer in time; and
similarity calculating means that calculates similarity among the learning data, the observed data, and the selected data closer in time all of which are modeled by the modeling means, wherein
anomaly detection is performed on the basis of the similarity calculated by the similarity calculating means.

26. An anomaly detection system, comprising:
input means that inputs observed data with an attribute of time related to an operation state of a plant or an installation from plural sensors installed at the plant or the installation;
learning data selecting means that, of learning data corresponding to nearly-normal data in a normal operation state of the plant or the installation, selects one closer in distance to the observed data and the other closer in time to the one closer in distance;
modeling means that models the learning data selected by the learning data selecting means in a low-dimensional subspace and selects data closer in time to the observed data input by the input means to model the observed data and the selected data closer in time in the low-dimensional subspace;
subspace similarity calculating means that calculates similarity between the subspaces formed by the learning data modeled by the modeling means and the subspace formed by the observed data and the selected data closer in time; and
anomaly detecting means that detects an anomaly using the information of the similarity of the subspaces calculated by the subspace similarity calculating means.
